(19) United States
(12) Patent Application Publication
(10) Pub. No.: US 2025/0268282 A1
(43) Pub. Date: Aug. 28, 2025

(54) SPLIT-FEEDING METHOD AND COMPOUND FEED FOR LAYING HENS

(71) Applicants: Gábor VARGA, Piliscsaba (HU); Zsolt FUCHS, Magyarpolány (HU); Boglárka HORVÁTH, Polgárdi (HU); László PÁL, Keszthely (HU); Henrik BARANYAY, Nagykovácsi (HU)

(72) Inventors: Gábor VARGA, Piliscsaba (HU); Zsolt FUCHS, Magyarpolány (HU); Boglárka HORVÁTH, Polgárdi (HU); László PÁL, Keszthely (HU); Henrik BARANYAY, Nagykovácsi (HU)

(21) Appl. No.: 18/549,744

(22) PCT Filed: May 11, 2022
(86) PCT No.: PCT/HU2022/050044

§ 371 Date: Sep. 8, 2023

(30) Foreign Application Priority Data
Mar. 11, 2021 (HU) P2100105

(51) Int. Cl. A23K 50/75; A23K 20/147; A23K 20/158; A23K 20/163; A23K 20/22; A23K 20/24; A23K 20/26

(52) U.S. Cl. CPC A23K 50/75; A23K 20/147; A23K 20/158; A23K 20/163; A23K 20/22; A23K 20/24; A23K 20/26

(57) ABSTRACT

The present invention relates to a method for feeding laying hens, wherein the daily feed ration is given to the hens in two phases, during the morning and afternoon feeding, wherein the morning feed ration has a higher protein content and a lower calcium content than the afternoon feed ration. For feed of 1 kg with a moisture content of 12%, the morning feed ration is prepared according to the following content values: 13-15% crude protein; 1.5-2% calcium; 0.2-0.75% phosphorus and 10-11.3 MJ metabolizable energy. The afternoon feed ration is prepared according to the following content values: 12-13.5% crude protein; 4-5.5% calcium; 0.1-0.8% phosphorus; and 9.8-10.2 MJ of metabolizable energy. The invention further relates to a morning and afternoon compound feed applicable in such a split-feeding method.

### TECHNICAL FIELD

The present invention relates to an environmentally friendly feeding method for laying hens, in which a daily, two-phase supply of a feed with an intrinsic value adapted to the energy, protein and calcium needs of egg production is achieved. The invention also relates to two types of compound feed supplied during said feeding process.

### BACKGROUND ART

In the traditional feeding of laying hens, during their daily feeding the animals are provided with a compound feed containing crude protein, amino acids, vitamins, calcium, phosphorus, trace elements and other minerals throughout the entire egg production period. These ingredients are chosen so that the feed meets the needs of the laying hens as much as possible, nevertheless economy is also an important consideration, as feeding is a significant cost factor in keeping hens.

In general, the daily feeding takes place in two to three phases, but the composition of the compound feed fed to the hens is the same throughout the day. This feeding method does not take into account the different protein and calcium needs of egg production on a daily basis, so hens take in more protein than they need in the afternoon. On the one hand, this is uneconomical, and on the other hand, the undigested protein that escapes rapidly through the short intestinal tract of hens is associated with excessive harmful emissions.

Patent document CN110100973A discloses a method in which the entire egg production time is divided into two periods and the fodders fed during each period differ in their composition. With this method, the protein and phosphorus content of the feed can be reduced significantly, and the utilization rate of crude protein is also increased. However, this feeding method does not take into account the fact that, due to the natural process of egg formation, the protein and—for the synthesis of egg shells—calcium intake of laying hens varies within a day, to differing degrees during the morning and the afternoon.

Compared to traditional technology using one kind of feed-mix, including the method described above, in which the period of egg production is divided into two periods and the feed is fed to birds of different composition during these periods, split feeding is more in line with the energy, protein and calcium needs of egg production, thus it can provide the same level of production with lower nutrient uptake. In practice, this means less daily feed intake per animal, i.e. specific feeding costs can be reduced and the economy is improved.

Another non-negligible advantage of a daily split-feeding is that it can reduce the amount of nitrogen (ammonia), calcium and phosphorus that are not utilized and released unnecessarily into the environment, hence significant environmental benefits can be attained. In terms of environmental impact, split feed technology can reduce greenhouse gas emissions getting to the environment by 10-15% compared to the conventional compound feed technology.

SU808079A1 discloses a feeding method of spliting on a daily basis for increasing the egg yield of hens. The document was filed in 1978 with a patent claim tailored to the needs of animals of a given genetics at the time. However, in the more than 40 years that have passed since then, the genetics of animals, and with them their feeding needs, have changed a lot. In addition, according to the patent document, they started to test the animals at the age of 150 days, which is approximately the peak period for egg production, and the feed content was determined on the basis of those tests. The deficiency of these studies is that they do not take into account the needs during the entire laying period, therefore the goal of increasing egg yield is achieved regarding only the peak period and not the entire laying period.

Document KR101847600B1 basically adjusts the protein-calcium ratios to the life stages of laying hens, during which three types of feed are given to hens, being in the age of pullet, in the first half of the laying age and in the second half of the laying age. Although the feeding method in question also mentions the supplying of the different daily doses of protein and calcium given in two phases, the solution does not teach the exact ranges of protein and calcium or the actual effects of the compound feeds fed accordingly.

### SUMMARY OF THE INVENTION

The object of the present invention is to provide split-feeding for hens throughout their entire laying period in which the animals have an ideal ratio of vitamins, micro- and macronutrients as well as fine-grained and coarse-grained calcium supplementation in a timely manner so that feeding be more economical, the amount of nitrogen, calcium and phosphorus that are not utilized and so released unnecessarily into the environment be reduced; further emissions of greenhouse gases into the environment be reduced all without compromising the quality of the eggshell, namely without reducing the weight and thickness of the eggshell. The feeding method according to the invention is preferably applied from the 22nd week of life of the hens, since it is advisable to start the split feeding practice before the start of the laying period; and typically used up to and including 100 weeks of age.

### DETAILED DESCRIPTION

To solve this problem, we have developed a method for feeding laying hens, wherein the daily feed ration is given to the hens in two phases, during the morning and afternoon feeding, wherein the morning feed has a higher protein content and a lower calcium content than the afternoon feed, further for a feed of 1 kg with a moisture content of 12%, the morning ration is prepared according to the following content values: 13-15% crude protein; 1.5-2% calcium; 0.2-0.75% phosphorus and 10-11.3 MJ metabolizable energy; and the afternoon ration is prepared according to the following content values: 12-13.5% crude protein; 4-5.5% calcium; 0.1-0.8% phosphorus; and 9.8-10.2 MJ of metabolizable energy.

Another aspect of the invention is a compound feed for the morning feeding of laying hens. A third aspect of the invention is a compound feed for the afternoon feeding of laying hens.

Experiments have confirmed the observation that laying hens are able to choose according to their physiological needs from the various formulations of feed offered to them at the same time. If hens are offered an energy- and protein-rich mixture and a calcium-rich feed throughout the day, the animals consume more of the energy-protein mixture in the morning and calcium-rich feed in the afternoon. To our knowledge, laying hens try to meet their different nutrient and calcium needs during the day of egg formation. In the morning the energy and protein requirements of egg albumen synthesis dominate, while in the afternoon the calcium requirement of eggshell formation prevail.

The traditional feeding system for laying hens usually involves feeding a mixture of the same composition, i.e. the hens are not able to absorb the nutrients and calcium in a rhythm and proportion that meets the physiological needs of egg production. A split-feeding system overcomes this disadvantage and thus has a number of positive benefits. Since split-feeding is more precisely tailored to the energy, protein, and calcium needs of egg production, it is able to provide the same level of production with less amount of nutrients. By this, the specific feeding costs can be reduced.

Another advantage of the technology is that it reduces the amount of nitrogen (ammonia), calcium and phosphorus that is not utilized and released unnecessarily into the environment. With a split-feeding system, the quality of the egg does not deteriorate, and there is even an improvement in the quality of the eggshell (thicker eggshell).

The morning and afternoon splitting of the content of the compound feed according to the invention are shown in the following table. Crude protein, metabolizable energy, calcium and phosphorus contents are typical of the present invention, while the other nutrient contents listed are in the preferred range. The content indicators refer to 1 kg of feed with a moisture content of 12%.

| | | In the | | In the | |
|---|---|---|---|---|---|
| | | morning | | afternoon | |
| Content values | | min | max | min | max |
| Dry matter | % | 85.00 | 95.00 | 85.00 | 95.00 |
| Crude protein | % | 13.00 | 15.00 | 12.00 | 13.50 |
| Crude oils and fats | % | 2.00 | 7.00 | 2.00 | 6.00 |
| Crude fiber | % | 3.00 | 7.00 | 3.50 | 9.00 |
| Crude ash | % | 10.00 | 17.00 | 11.00 | 20.00 |
| Starch | % | 30.00 | 60.00 | 20.00 | 55.00 |
| AMEn poultry | MJ | 10.00 | 11.70 | 9.50 | 11.50 |
| ME (poultry metabolizable energy) | MJ | 10.00 | 11.30 | 9.80 | 10.20 |
| Lysine | % | 0.50 | 1.00 | 0.40 | 0.95 |
| Methionine | % | 0.25 | 0.50 | 0.20 | 0.48 |
| Methionine-cystine ratio | % | 0.40 | 0.90 | 0.30 | 0.85 |
| Threonine | % | 0.40 | 0.70 | 0.30 | 0.68 |
| Ca (without phytase matrix) | % | 1.50 | 2.00 | 4.00 | 5.50 |
| P (without phytase matrix) | % | 0.20 | 0.75 | 0.1 | 0.80 |
| Na | % | 0.10 | 0.20 | 0.10 | 0.20 |

Where ME means: metabolizable energy = (energy absorbed by feed − energy excreted in faeces)/amount of feed consumed).

AMEn means apparent metabolizable energy corrected for zero nitrogen retention. Multivariate linear regression equations take into account the nutrient categories of the feeds and their potential metabolizable energy value measured in the laboratory. In the countries of the European Union, including Hungary, the following equation is used to calculate the AMEn content of poultry feeds and to check the energy level of the feeds: AMEn (MJ/kg)=0.1551 crude protein+0.3431 crude fat+0.1669 starch+0.1301 sugar. (Source: Prof. Dr. DUBLECZ Károly: ‘Poultry feeding’ (‘Baromfitakarmányozás’), Educational aid on Animal Breeding for MSc students specialized in feeding and feed safety engineering, 2011, Pannon University, Hungary)

Relevant amino acids are as follows: lysine, methionine, methionine-cystine, threonine. The values of protein, fat, fiber and ash refer to 1 kg of feed with a moisture content of 12%; determined by standard lab-analytical methods for the general characterization of feeding materials. These values can be interpreted separately and there is no correlation between them.

The feed materials described in the table contain the following ingredients: maize, extracted soybean meal, wheat flour, extracted sunflower meal, DDGS, feed wheat and a premix containing vitamins, micro-and macro-nutrients. Recipes are mainly based on corn with almost 50%, the remaining part mainly contain 20% soybean meal and 20% wheat. Additionals factors in the composition of feed are the availability of raw materials as well as the purchase price.

The following examples illustrate the beneficial physiological and environment-friendly effects associated with some of the preferred morning and afternoon content values of the feeding method of the present invention. The content indicators refer to 1 kg of feed with a moisture content of 12%.

### Example 1

Content values of the feed fed in the morning: crude protein 13%, metabolizable energy: 11 MJ, calcium 1.5%, phosphorus 0.4%. Content values of the feed fed in the afternoon: crude protein 12%, metabolizable energy: 10 MJ, calcium 4.3%, phosphorus 0.4%. As a result of the feeding according to the example, the nitrogen emission of the laying hens is 30 (ppm) % (−10% per crude protein percentage), the calcium retention is 10%, the phosphorus retention is 20%, the greenhouse gas emission is 3 (ppm), and the eggshell quality is 2 (kgf) %.

### Example 2

Content values of the feed fed in the morning: crude protein 13%, metabolizable energy: 11 MJ, calcium 1.7%, phosphorus 0.4%. Content values of the feed fed in the afternoon: crude protein 12%, metabolizable energy: 10 MJ, calcium 5.2%, phosphorus 0.4%. As a result of the feeding according to the example, the nitrogen emission of the laying hens is 30 (ppm) % (−10% per crude protein percentage), the calcium retention is 8%, the phosphorus retention is 18%, the greenhouse gas emission is 2.5 (ppm) %, and the eggshell quality is 3 (kgf) %.

### Example 3

Content values of the feed fed in the morning: crude protein 14.5%, metabolizable energy: 11 MJ, calcium 1.5%, phosphorus 0.4%. Content values of the feed fed in the afternoon: crude protein 12.5%, metabolizable energy: 10 MJ, calcium 4.3%, phosphorus 0.4%. As a result of the feeding according to the example, the nitrogen emission of the laying hens is 15 (ppm) % (−10% per crude protein percentage), the calcium retention is 9%, the phosphorus retention is 20%, the greenhouse gas emission is 2.2 (ppm) %, and the eggshells quality is 2 (kgf) %.

### Example 4

Content values of the feed fed in the morning: crude protein 14.5%, metabolizable energy: 11 MJ, calcium 1.7%, phosphorus 0.4%. Content values of the feed fed in the afternoon: crude proteinn 12.5%, metabolizable energy: 10 MJ, calcium 5.2%, phosphorus 0.4%. As a result of the feeding according to the example, the nitrogen emission of the laying hens is 15 (ppm) % (−10% per crude protein percentage), the calcium retention is 7%, the phosphorus retention is 17%, the greenhouse gas emission is 2 (ppm) %, and the eggshell quality is 3 (kgf) %.

### Example 5

Content values of the feed fed in the morning: crude protein 14%, metabolizable energy: 11 MJ, calcium 1.6%, phosphorus 0.4%. Content values of the feed fed in the afternoon: crude protein 13%, metabolizable energy: 10 MJ, calcium 4.5%, phosphorus 0.4%. As a result of the feeding according to the example, the nitrogen emission of the laying hens is 20 (ppm) % (−10% per crude protein percentage), the calcium retention is 6%, the phosphorus retention is 16%, the greenhouse gas emission is 2.1 (ppm) %, the eggshells quality is 2.1 (kgf) %.

### Example 6

Content values of the feed fed in the morning: crude protein 14%, metabolizable energy: 11 MJ, calcium 1.8%, phosphorus 0.4%. Content values of the feed fed in the afternoon: crude protein 13%, metabolizable energy: 10 MJ, calcium 4.5%, phosphorus 0.4%. As a result of the feeding according to the example, the nitrogen emission of the laying hens is 20 (ppm) % (−10% per crude protein percentage), the calcium retention is 5%, the phosphorus retention is 15%, the greenhouse gas emission is 2.3 (ppm) %, and the eggshell quality is 2.3 (kgf) %.

### Example 7

Content values of the feed fed in the morning: crude protein 14.8%, metabolizable energy: 11 MJ, calcium 1.6%, phosphorus 0.4%. Content values of the feed fed in the afternoon: crude protein 12.2%, metabolizable energy: 10 MJ, calcium 4.5%, phosphorus 0.4%. As a result of the feeding according to the example, the nitrogen emission of the laying hens is 15 (ppm) % (−10% per crude protein percentage), the calcium retention is 5.5%, the phosphorus retention is 16%, the greenhouse gas emission is 2 (ppm) %, and the eggshell quality is 2.2 (kgf) %.

### Example 8

Content values of the feed fed in the morning: crude protein 14.8%, metabolizable energy: 11 MJ, calcium 1.8%, phosphorus 0.4%. Content values of the feed fed in the afternoon: crude protein 12.2%, metabolizable energy: 10 MJ, calcium 4.5%, phosphorus 0.4%. As a result of the feeding according to the example, the nitrogen emission of the laying hens is 10 (ppm) % (−10% per crude protein percentage), the calcium retention is 5%, the phosphorus retention is 15%, the greenhouse gas emission is 2 (ppm) %, and the eggshell quality 2.4 (kgf) %.

In addition to the economic benefits, such as keeping egg production at an appropriate level, the examples listed show that significant ecological and environmentally sound effects can also be achieved by using compound feeds defined with the content value-ranges of the present invention in a split-feeding system.

1. (canceled)

2. The method for feeding according to claim 8, further comprising:
preparing the morning feed ration to further contain the following content values for the 1 kg of feed with the moisture content of 12%:
85-95% dry matter;
2-7% crude oil and fat;
3-7% crude fiber;
10-17% crude ash;
30-60% starch;
0.5-1% lysine;
0.25-0.5% methionine;
0.4-0.9% methionine-cystine;
0.4-0.7% threonine;
0.1-0.2% sodium; and
apparent metabolizable energy corrected for 10-11.7 MJ nitrogen retention.

3. The method for feeding according to claim 8, further comprising:
preparing the afternoon feed ration to further contain the following content values for the 1 kg of feed with the moisture content of 12%:
85-95% dry matter;
2-6% crude oil and fat;
3.5-9% crude fiber;
11-20% crude ash;
20-55% starch;
0.4-0.95% lysine;
0.2-0.48% methionine;
0.3-0.85% methionine-cystine;
0.3-0.68% threonine;
0.1-0.2% sodium; and
apparent metabolizable energy corrected for 9.5-11.5 MJ nitrogen retention.

4. A compound feed for morning feeding of laying hens, wherein for 1 kg of feed with a moisture content of 12%, the compound feed contains the following content values:
13-15% crude protein;
1.5-2% calcium;
0.2-0.75% phosphorus; and
10-11.3 MJ of metabolizable energy.

5. The compound feed according to claim 4, wherein the 1 kg of feed with the moisture content of 12% further contains the following content values:
85-95% dry matter;
2-7% crude oil and fat;
3-7% crude fiber;
10-17% crude ash;
30-60% starch;
0.5-1% lysine;
0.25-0.5% methionine;
0.4-0.9% methionine-cystine;
0.4-0.7% threonine;
0.1-0.2% sodium; and
apparent metabolizable energy corrected for 10-11.7 MJ nitrogen retention.

6. A compound feed for afternoon feeding of laying hens, wherein for 1 kg of feed with a moisture content of 12%, the compound feed contains the following content values:
12-13.5% crude protein;
4-5.5% calcium;
0.1-0.8% phosphorus; and
9.8-10.2 MJ of metabolizable energy.

7. The compound feed according to claim 6, wherein the 1 kg of feed with the moisture content of 12% further contains the following content values:
85-95% dry matter;
2-6% crude oil and fat;
3.5-9% crude fiber;
11-20% crude ash;
20-55% starch;
0.4-0.95% lysine;
0.2-0.48% methionine;
0.3-0.85% methionine-cystine;
0.3-0.68% threonine;
0.1-0.2% sodium; and
apparent metabolizable energy corrected for 9.5-11.5 MJ nitrogen retention.

8. A method for feeding laying hens comprising steps of:
giving a daily feed ration to the laying hens in two phases;
separating the two phases into a morning feed ration and an afternoon feed ration;
providing the morning feed ration with a higher protein content and a lower calcium content than the afternoon feed ration;
preparing the morning feed ration according to the following content values for 1 kg of feed with a moisture content of 12%:
13-15% crude protein;
1.5-2% calcium;
0.2-0.75% phosphorus; and
10-11.3 MJ metabolizable energy;
preparing the afternoon feed ration according to the following content values for 1 kg of feed with a moisture content of 12%:
12-13.5% crude protein;
4-5.5% calcium;
0.1-0.8% phosphorus; and
9.8-10.2 MJ of metabolizable energy.

9. The method for feeding according to claim 2, further comprising:
preparing the afternoon feed ration to further contain the following content values for the 1 kg of feed with the moisture content of 12%:
85-95% dry matter;
2-6% crude oil and fat;
3.5-9% crude fiber;
11-20% crude ash;
20-55% starch;
0.4-0.95% lysine;
0.2-0.48% methionine;
0.3-0.85% methionine-cystine;
0.3-0.68% threonine;
0.1-0.2% sodium; and
apparent metabolizable energy corrected for 9.5-11.5 MJ nitrogen retention.
